(19) United States
(12) Patent Application Publication
(10) Pub. No.: US 2012/0293028 A1
(43) Pub. Date: Nov. 22, 2012

(54) BEARING ASSEMBLY AND SPINDLE MOTOR INCLUDING THE SAME

(75) Inventors: Ju Ho Kim, Gyunggi-do (KR); Shin Young Cheong, Gyunggi-do (KR); Ki Suk Woo, Seoul (KR)

(73) Assignee: SAMSUNG ELECTRO-MECHANICS CO., LTD., Gyunggi-do (KR)

(21) Appl. No.: 13/204,081

(22) Filed: Aug. 5, 2011

(30) Foreign Application Priority Data
May 16, 2011 (KR) 1020110045778

(51) Int. Cl. H02K 7/08; F16C 17/00; F16C 32/06

(52) U.S. Cl. 310/90; 384/107; 384/129

(57) ABSTRACT

Disclosed herein are a bearing assembly and a spindle motor including the same. The bearing assembly includes: a shaft having a first magnet formed on an outer circumferential surface thereof; and a sleeve having a second magnet formed on an inner circumferential surface thereof, and spaced apart from the first magnet to face the first magnet, the sleeve supporting the shaft, wherein a spaced gap between the first magnet and the second magnet is filled with oil. According to the present invention, power consumption due to driving of the spindle motor can be reduced by using the bearing assembly included in the magnetic bearing.

### CROSS REFERENCE TO RELATED APPLICATION

This application claims the benefit of Korean Patent Application No. 10-2011-0045778, filed on May 16, 2011, entitled “Bearing Assembly and Spindle Motor Comprising thereof”, which is hereby incorporated by reference in its entirety into this application.

### BACKGROUND OF THE INVENTION

1. Technical Field

The present invention relates to a bearing assembly and a spindle motor including the same.

2. Description of the Related Art

Generally, a spindle motor pertains to a brushless-DC motor (BLDC), and is widely used as a motor for a hard disk drive as well as a laser beam scanner motor for a laser printer, a motor for a floppy disk driver (FDD), a motor for an optical disk drive such as a compact drive (CD) or a digital versatile disk (DVD), or the like.

Recently, in a device, such as a hard disk drive, which requires high capacity and high-speed driving force, a spindle motor to which a hydrodynamic bearing with small drive friction is applied rather than an existing ball bearing is more generally used, in order to minimize noise, and non repeatable run out (NRRO), which is vibration generated at the time of employing the ball bearing. In the hydrodynamic bearing, basically, a thin oil film is formed between a rotator and a stator, which are supported by pressure generated at the time of rotation, and thus, contact between the rotator and stator does not occur, thereby reducing friction load. Therefore, in the spindle motor to which the hydrodynamic bearing is applied, a lubricant oil (hereinafter, referred to ‘operating fluid’) enables a shaft of the motor rotating a disk to be supported by only dynamic pressure (which return oil pressure to the center by centrifugal force of a rotational shaft. Therefore, the spindle motor is differentiated from a ball bearing spindle motor where a shaft is supported by steel balls.

When this hydrodynamic bearing is applied to the spindle motor, the rotator is supported by using fluid, and thus, the amount of noise generated in the motor is small and power consumption is less.

However, recently, in the spindle motor to which the hydrodynamic bearing is applied, there is a problem in that a frictional force due to oil, which is the operating fluid, to proportionally increases the driving current. In addition, there was an attempt in which a magnetic bearing structure using a repulsive force between permanent magnets is applied. However, as air fills between the magnets, damping characteristics are worse, and thus, the reliability on the response characteristic is lowered due to external impact.

### SUMMARY OF THE INVENTION

The present invention has been made in an effort to provide a bearing assembly for reducing frictional force and driving current of a hydrodynamic bearing and improving damping characteristics of a magnet bearing, and a spindle motor including the same.

According to a preferred embodiment of the present invention, there is provided a bearing assembly, including: a shaft having a first magnet formed on an outer circumferential surface thereof; and a sleeve having a second magnet formed on an inner circumferential surface thereof, and spaced apart from the first magnet to face the first magnet, the sleeve supporting the shaft, wherein a spaced gap between the first magnet and the second magnet is filled with a viscous fluid.

The second magnet may include: a second upper magnet formed on an inner circumferential surface of the sleeve upwardly in an axial direction, the second upper magnet facing the first magnet; and a second lower magnet formed on the inner circumferential surface of the sleeve and spaced apart from the second upper magnet downwardly in the axial direction, the second lower magnet facing the first magnet.

The first magnet may include: a first upper magnet formed on an outer circumferential surface of the shaft upwardly in the axial direction, the first upper magnet facing the second upper magnet; and a first lower magnet formed on the outer circumferential surface of the shaft and spaced apart from the first upper magnet downwardly in the axial direction, the first lower magnet facing the second lower magnet.

The first magnet and the second magnet may have respective upper surfaces in the axial direction, of which one height is equal to or higher than the other height.

The bearing assembly may further include a hydrodynamic bearing part including: a radial dynamic part having the shaft and the sleeve facing each other in the axial direction; and a thrust dynamic part by a thrust plate formed to face an end portion of the sleeve.

The shaft or the sleeve may be formed of a magnetic material.

According to another preferred embodiment of the present invention, there is provided a spindle motor, including: the bearing assembly as described above, a base coupled with the sleeve and having a coil-wound core mounted thereon; and a hub having a magnet mounted thereon to face the core and coupled with the shaft at the rotation center thereof.

### BRIEF DESCRIPTION OF THE DRAWINGS

FIG. 1 is a schematic cross-sectional view of a spindle motor including a bearing assembly according to a first preferred embodiment of the present invention;

FIG. 2 is a perspective view of the bearing assembly shown in FIG. 1;

FIG. 3 is a schematic cross-sectional view of a spindle motor including a bearing assembly according to a second preferred embodiment of the present invention;

FIG. 4 is a schematic cross-sectional view of a spindle motor including a bearing assembly according to a third preferred embodiment of the present invention;

FIG. 5 is a schematic cross-sectional view of a spindle motor including a bearing assembly according to a fourth preferred embodiment of the present invention;

FIG. 6 is a schematic cross-sectional view of a spindle motor including a bearing assembly according to a fifth preferred embodiment of the present invention;

FIGS. 7 and 8 are schematic cross-sectional views of a structure of a magnetic bearing where magnets are magnetized in a radial direction;

FIGS. 9 and 10 are schematic cross-sectional views of a structure of a magnetic bearing where magnets are magnetized in an axial direction; and

FIG. 11 is a schematic cross-sectional view of a spindle motor including a bearing assembly where a magnetic bearing and a hydrodynamic bearing are combined.

### DESCRIPTION OF THE PREFERRED EMBODIMENTS

Various objects, advantages and features of the invention will become apparent from the following description of preferred embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. In the description, the terms “one surface”, “the other surface”, “first”, “second” and so on are used to distinguish one element from another element, and the elements are not defined by the above terms. In the present invention, an “axial direction” refers to a longitudinal direction in which a shaft of the present invention is coupled, and the axial direction is a direction vertical to a direction in which the shaft is rotated. Hereinafter, in describing the present invention, a detailed description of related known functions or configurations will be omitted so as not to obscure the gist of the present invention.

Hereinafter, preferred embodiments of the present invention will be described in detail with reference to the accompanying drawings.

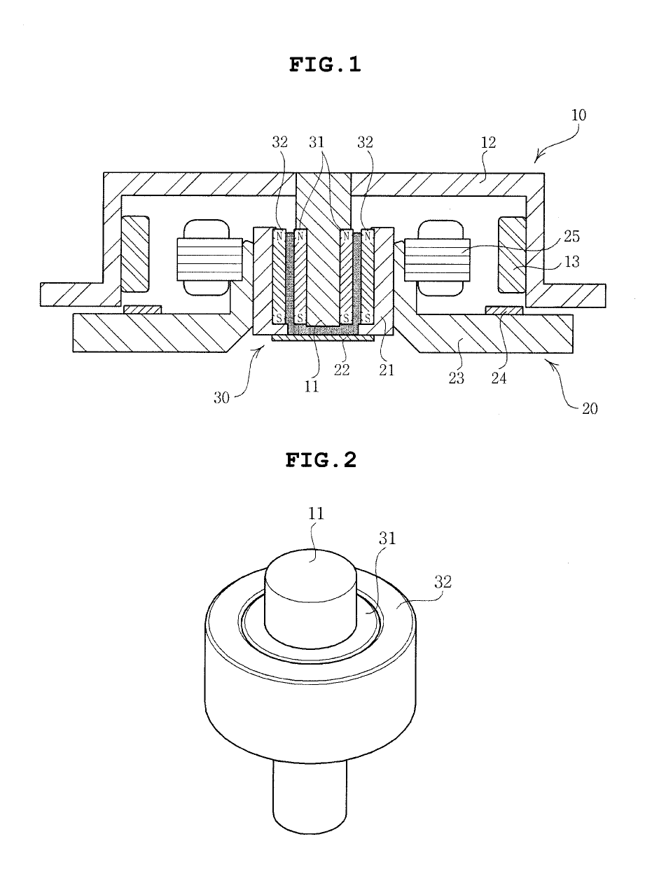

FIG. 1 is a schematic cross-sectional view of a spindle motor including a bearing assembly according to a first preferred embodiment of the present invention, and FIG. 2 is a perspective view of the bearing assembly shown in FIG. 1.

A bearing assembly 30 according to the present invention includes a shaft 11 having a first magnet 31 formed on an outer circumferential surface thereof, and a sleeve 21 having a second magnet 32 formed on an inner circumferential surface thereof. The second magnet 32 is spaced apart from the first magnet 31 to face the first magnet 31. Here, the sleeve 21 supports the shaft 11. A viscous fluid fills a spaced gap between the first magnet 31 and the second magnet 32.

The shaft 11 is coupled to the center of a hub 12, and rotated while inserted into the sleeve 21. The shaft 11 is generally made in a cylindrical shape. The shaft 11 is coupled to match the rotation center on which a rotating part 10 of the spindle motor rotates, and the sleeve 21 is formed on an outer circumferential surface of the shaft 11 such that the sleeve 21 surrounds the shaft 11 to rotatably support the shaft 11. The first magnet 31 for a structure of a magnetic bearing is formed on the outer circumferential surface of the shaft 11. As shown in FIG. 1, the first magnet 31 may be formed in an integrated permanent magnet. In a case where the first magnet 31 is formed on the outer circumferential surface of the shaft 11, it may be easily coupled and bonded to the shaft 11 by making a step on the outer circumferential surface of the shaft 11.

The second magnet 32 is formed on the inner circumferential surface of the sleeve 21 such that it is correspondingly spaced apart from the first magnet 31 formed on the outer circumferential surface of the shaft 11 while the sleeve 21 supports the shaft 11. The coupling of the second magnet 32 with respect to the sleeve 21 may be performed by making a step on the inner circumferential surface of the sleeve 21, and the type of coupling is not limited thereto. The second magnet 32 may be coupled with the sleeve 21 in various attachment types. The sleeve 21 may have a coupling hole (not shown) for coupling with the shaft 11.

The viscous fluid may fill the spaced gap between the first magnet 31 formed on the outer circumferential surface of the shaft 11 and the second magnet 32 formed on the inner circumferential surface of the sleeve 21 and correspondingly spaced apart from the first magnet 31. Here, the viscous fluid is characterized to be an oil 40, and any various materials that have high viscosity and can help driving of the magnetic bearing may be used as the viscous fluid. As shown in FIG. 2, the first magnet 31 and the second magnet 32 may be coupled with each other in a cylindrical shape such that they correspond to the shaft 11 and the sleeve 21, respectively. The cylindrical shape need not be continuous, and may be discontinuous. It would be obvious to those skilled in the art that the cylindrical shape may be appropriately changed into other shapes depending on the structures of the shaft 11 and the sleeve 21. The first magnet 31 rotates together with rotation of the rotating part 10 including the shaft 11, and the second magnet 32 may be coupled to the sleeve 21 of a stationary part 20.

The sleeve 21 may further include a cover member 22 at an end portion thereof in the axial direction. The cover member 22 can prevent leakage of oil 40 of the magnetic bearing, and at the same time, function to support the sleeve 21.

The first magnet 31 and the second magnet 32 composing a structure of the magnetic bearing may be formed such that magnetic polarities thereof face each other. Here, the first magnet 31 and the second magnet 32 may be magnetized in an axial direction or in a radial direction.

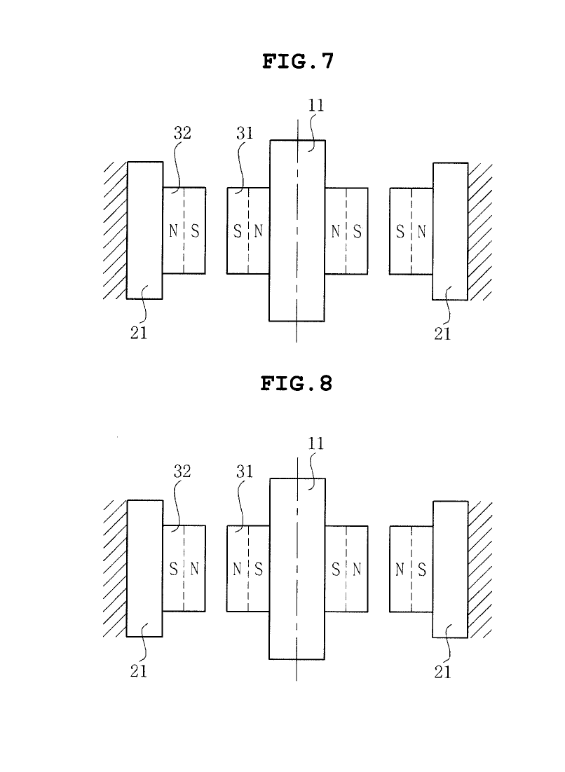

As shown in FIGS. 7 and 8, the first magnet 31 and the second magnet 32 of the magnetic bearing may be magnetized in a radial direction. When the first magnet 31 and the second magnet 32 are disposed such that the same magnetic poles face each other, a repulsive force is applied therebetween, and thus the spindle motor is rotated. In the present invention, the viscous fluid, such as oil 40, fills the spaced gap where the repulsive force by the first magnet 31 and the second magnet 32 is applied. Using of a high viscous fluid can prevent the fluid within the magnetic bearing from leaking or scattering to the outside at the time of operating the spindle motor. As will be described later, since a frictional force is proportional to viscosity and inversely proportional to a distance of a spaced gap between the first magnet 31 and the second magnet 32, when the spaced gap between the first magnet 31 and the second magnet 32 of the magnetic bearing is sufficiently large, the frictional force due to increase of viscosity does not have a large effect on the operation of the spindle motor even though high viscous fluid is used.

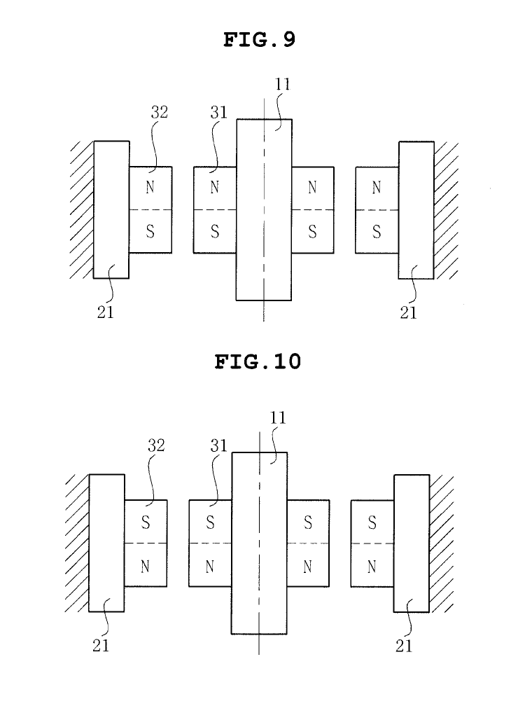

As shown in FIGS. 9 and 10, the first magnet 31 and the second magnet 32 of the magnetic bearing are magnetized in an axial direction. Even though the first magnet 31 and the second magnet 32 are magnetized in the axial direction, they may be disposed such that the same magnetic polarities face each other to apply a repulsive force therebetween. The present invention is described and explained with regard to a case where the first magnet 31 and the second magnet 32 are magnetized in the axial direction, but the present invention is not limited thereto. It would be obvious to those skilled in the art that a case where the magnets are magnetized in the radial direction may be applied in the same way.

The present invention can improve damping characteristics of the magnetic bearing by filling between the first magnet 31 and the second magnet 32 with a fluid having viscosity, such as oil 40 or the like. When damping is performed by using air formed between the magnets for the magnetic bearing of the prior art, there is a problem in that the reliability on a response characteristic to external impact or the like reduces. However, a viscous fluid such as oil 40 of the present invention fills the spaced gap between the first magnet 31 and the second magnet 32 composing the magnetic bearing, thereby improving damping characteristics of the magnetic bearing. The frictional force is proportional to the viscosity of fluid formed, and inversely proportional to a distance of a spaced gap, which is an interval filled with oil. Therefore, the distance of the spaced gap between the first magnet 31 and the second magnet 32 forming the magnetic bearing can be spaced apart to be (at least two times) larger even more than a distance of a gap where fluid is provided in the hydrodynamic bearing of the prior art. Here, the increase in viscosity due to oil 40 filling the magnetic bearing is insignificant compared with the increased distance, and thus, the frictional force due to oil 40 does not have a large effect on the operating characteristic of the spindle motor. Rather, the damping characteristics of the magnetic bearing can be improved by the viscous fluid, that is, oil 40 filling between the first magnet 31 and the second magnet 32 composing the magnetic bearing, thereby still further improving the operating characteristic and reliability of the spindle motor.

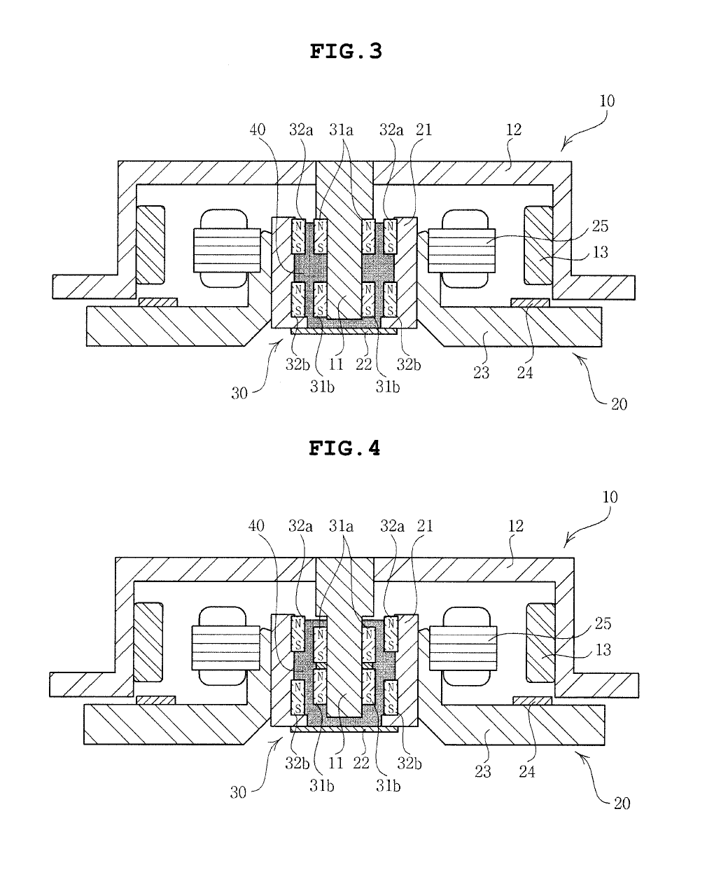

FIGS. 3 to 6 illustrate various structures and directions in which the first magnet 31 and the second magnet 32 composing a bearing assembly according to the present invention are magnetized.

FIG. 3 is directed to a spindle motor including a bearing assembly 30 according to a second preferred embodiment of the present invention. The first magnet 31 on the outer circumferential surface of the shaft 11 may include a first upper magnet 31a formed upwardly in an axial direction, and a first lower magnet 31b formed downwardly in the axial direction and spaced apart from the first upper magnet 31a. Here, the second magnet 32 may be formed on the inner circumferential surface of the sleeve 21 correspondingly to the first upper magnet 31a and the first lower magnet 31b. More specifically, a second upper magnet 32a may be formed correspondingly to the first upper magnet 31a, and a second lower magnet 32b may be formed correspondingly to the first lower magnet 31b. Here, the second lower magnet 32b is formed downwardly in the axial direction and spaced apart from the second upper magnet 32a. The direction in which the magnets are magnetized may be in the axial direction, but is not limited thereto. For example, the direction of the magnetization may be in the radial direction. The corresponding magnets may be disposed such that the same magnet polarities face each other, and thus, mutual repulsive force is applied therebetween.

In a structure of a magnetic bearing shown in FIGS. 4 to 6, the first magnet 31 and the second magnet 32 may be correspondingly formed to deviate from the center, thereby securing rigidity in the axial direction. In FIG. 4, a rotating magnet rotating together with the shaft 11 includes a first upper magnet 31a and a first lower magnet 31b formed on the outer circumferential surface of the shaft 11 upwardly and downwardly in the axial direction, respectively, while the first upper magnet 31a is spaced apart from the first lower magnet 31b. A stationary magnet corresponding to this may include a second upper magnet 32a and a second lower magnet 32b formed on inner circumferential surface of the sleeve 21. The second upper magnet 32a and the second lower magnet 32b may be disposed at the positions corresponding to the first upper magnet 31a and the first lower magnet 31b such that the same magnetic polarities face each other, resulting in mutual repulsive force. Particularly, upper and lower surfaces of the first upper magnet 31a in the axial direction may be disposed lower than the upper and lower surfaces of the corresponding second upper magnet 32a in the axial direction, and upper and lower surfaces of the first lower magnet 31b in the axial direction may be disposed higher than the upper and lower surfaces of the corresponding second lower magnet 32b in the axial direction (See, FIG. 4). Also, a case contrary to this may be possible (See, FIG. 6).

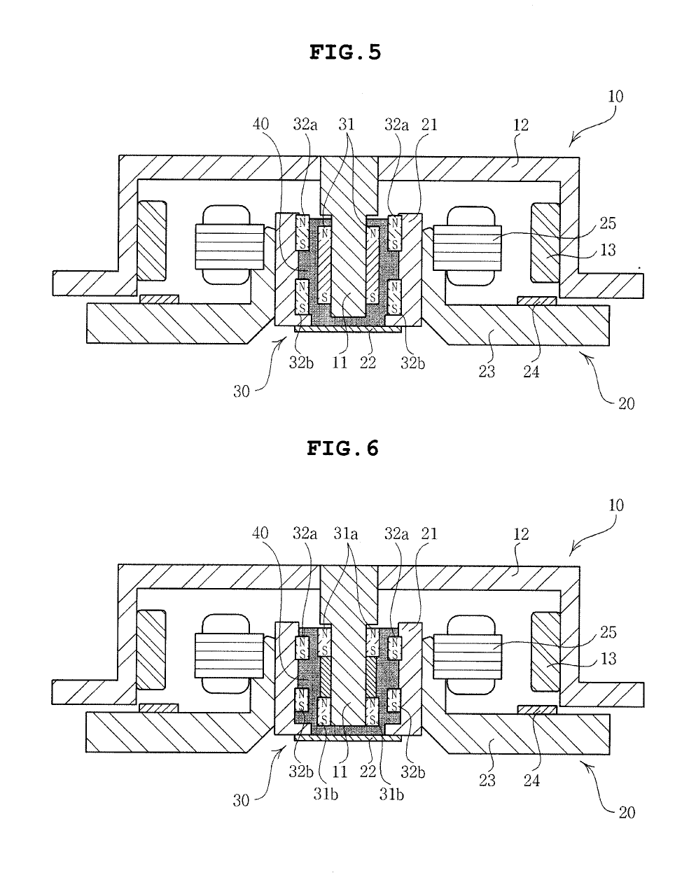

Furthermore, as shown in FIG. 5, the first magnet 31 is formed as one body type, and then the second upper magnet 32a and the second lower magnet 32b may be formed at corresponding positions, respectively. More specifically, the second upper magnet 32a may be disposed to have an upper surface higher than that of the first magnet 31 in the axial direction, and the second lower magnet 32b may be disposed to have a lower surface lower than that of the first magnet 31 in the axial direction.

As shown in FIGS. 4 to 6, when the first magnet 31 and the second magnet 32 are correspondingly formed to deviate from the center, a repulsive force in the radial direction as well as a repulsive force in the axial direction is generated. Therefore, this center deviation of the magnets may be used to secure rigidity in the axial direction even without a separate thrust bearing.

In addition, the shaft 11 with the first magnet 31 and the sleeve 21 with the second magnet 32 may be formed of a magnetic material, thereby functioning as a york as well. As such, both the shaft 11 and the sleeve 21 function as a york, thereby lightening products and simplifying assembling as well as increasing magnetic flux density inside the magnetic bearing to improve rigidity of the magnetic bearing. Here, the shaft 11 or the sleeve 21 may be selectively formed by using a magnetic material, and both members (shaft 11 and sleeve 21) may be formed by using a magnetic material as well.

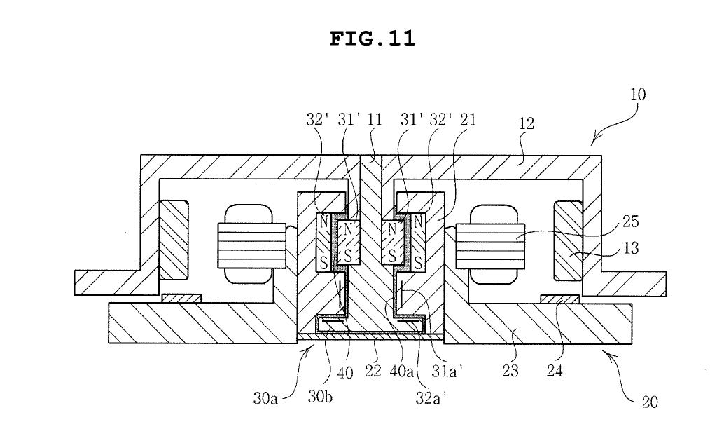

FIG. 11 is a schematic cross-sectional view of a spindle motor including a bearing assembly 30a where a magnetic bearing and a hydrodynamic bearing are combined. Here, the bearing assembly 30a further includes a hydrodynamic bearing part including a radial dynamic part 31a′ where the shaft 11 and the sleeve 21 face each other in the axial direction, and a thrust dynamic part 32a′ in the axial direction by a thrust plate 30b formed to face an end portion of the sleeve 21. In other words, a hybrid spindle motor where a magnetic bearing and a hydrodynamic bearing part are combined is provided.

The magnetic bearing is formed upwardly in the axial direction and the hydrodynamic bearing part is formed downwardly in the axial direction, based on the shaft 11. The structure with respect to the magnetic bearing formed upwardly in the axial direction was already described as above, and thus the detailed description thereof will be omitted.

The hydrodynamic bearing part may be formed downwardly in the axial direction of the magnetic bearing, and may include the radial dynamic part 31a′ and the thrust dynamic part 32a′. The radial dynamic part 31a′ is formed at a position where the shaft 11 and the sleeve 21 face each other in the axial direction with oil 40a filled therebetween. The thrust dynamic part 32a′ is formed by the thrust plate 30b formed at a lower end of the shaft 11.

The radial dynamic part 31a′ is filled with oil 40a, which is operating fluid, filling to the gap between the shaft 11 and the sleeve 21. A spiral-shaped, herring bone-shaped, or screw-shaped dynamic groove for forming the thrust dynamic part 32a′ may be formed on the inner circumferential surface of the sleeve 21, but the shape of the dynamic groove is not limited thereto. Various shapes can be employed for generation of radial dynamic pressure.

The thrust plate 30b may be formed downwardly in the axial direction of the sleeve 21 and vertically to the axial direction. The thrust plate 30b may be coupled with the shaft 11, or integrated with the shaft 11 as one body. Also, the thrust plate 30b is rotated together with the shaft 11 to form the thrust dynamic part 32a′ in the axial direction. A dynamic groove of a spiral shape or a herring bone shape may be formed on an upper surface and a lower surface of the thrust plate 30b, and any shape that can form the thrust dynamic part 32a′ may be employed for the dynamic groove. The rigidity in the axial direction can be improved due to the thrust dynamic part 32a′ formed by the thrust plate 30b.

The spindle motor including the bearing assembly according to the present invention includes the bearing assembly, a base 23 where the sleeve 21 is coupled and a core 25 wound by coil is installed, and a hub 12 where a magnet 13 is installed to face the core 25 and the shaft 11 is coupled to the rotation center.

The bearing assembly may include both a magnetic bearing and a bearing assembly where a magnetic bearing and a hydrodynamic bearing part are combined.

An operating example of the spindle motor including the bearing assembly according to the present invention will be described as follows.

The rotating part 10 may be configured to include the shaft 11 formed to rotate as the center of rotation, and the hub 12 coupled to an upper portion of the shaft 11 and having the magnet 13 attached thereon. The stationary part 20 may include the base 23, the sleeve 21, the core 25, and a pulling plate 24. The core 25 and the magnet 13 are attached at the position facing each other outside of the base 23 and inside of the hub 12, respectively. Here, current flows through the core 25, thereby forming magnetic field and generating magnetic flux. The magnet 13 facing the core 25 has N and S magnetic poles repeatedly magnetized, thereby forming an electrode correspondingly to a variable electrode generated from the core 25. The core 25 and the magnet 13 generate mutual repulsive force by electromagnetic force due to interlinkage of magnetic flux, and thus, the hub 12 and the shaft 11 coupled therewith are rotated, thereby driving the spindle motor of the present invention. In addition, in order to prevent floating at the time of driving the motor, the pulling plate 24 is formed on the base 23 correspondingly to the magnet 13 in the axial direction. An attractive force is applied between the pulling plate 24 and the magnet 13, thereby allowing stable rotation driving.

In particular, according to the present invention, power consumption can be significantly reduced through the structure of the magnetic bearing at the time of driving the spindle motor, and damping effects can be improved by filling the spaced gap between the first magnet and the second magnet for the magnetic bearing with viscous fluid, that is, oil. In addition, through a combined structure of the magnetic bearing and the hydrodynamic bearing, damping characteristics of the magnetic bearing can be further improved and current consumption can be reduced at the time of operating the spindle motor, compared with the prior art.

According to the preferred embodiments of the present invention, power consumption due to driving of the spindle motor can be reduced by using the bearing assembly included in the magnetic bearing.

Furthermore, damping characteristics of the magnetic bearing can be improved by filling the spaced gab between the facing first and second magnets for forming the magnetic bearing.

Furthermore, rigidity of the magnetic bearing can be improved by forming the shaft and the sleeve having the first magnet and the second magnet of magnetic materials to increase magnetic flux density inside the magnetic bearing.

Furthermore, rigidity in the axial direction can be improved through a repulsive force in the axial direction by forming the first magnet and the second magnet of the magnetic bearing correspondingly each other such that they deviate from the center.

Furthermore, viscous fluid for filling the magnetic bearing can be prevented from leaking to the outside by using high viscous fluid as the viscous fluid.

Although the preferred embodiments of the present invention have been disclosed for illustrative purposes, they are for specifically explaining the present invention and thus a bearing assembly and a spindle motor including the same according to the present invention are not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A bearing assembly, comprising:
a shaft having a first magnet formed on an outer circumferential surface thereof; and
a sleeve having a second magnet formed on an inner circumferential surface thereof, and spaced apart from the first magnet to face the first magnet, the sleeve supporting the shaft,
wherein a spaced gap between the first magnet and the second magnet is filled with a viscous fluid.

2. The bearing assembly as set forth in claim 1, wherein the second magnet includes:
a second upper magnet formed on an inner circumferential surface of the sleeve upwardly in an axial direction, the second upper magnet facing the first magnet; and
a second lower magnet formed on the inner circumferential surface of the sleeve and spaced apart from the second upper magnet downwardly in the axial direction, the second lower magnet facing the first magnet.

3. The bearing assembly as set forth in claim 2, wherein the first magnet includes:
a first upper magnet formed on an outer circumferential surface of the shaft upwardly in the axial direction, the first upper magnet facing the second upper magnet; and
a first lower magnet formed on the outer circumferential surface of the shaft and spaced apart from the first upper magnet downwardly in the axial direction, the first lower magnet facing the second lower magnet.

4. The bearing assembly as set forth in claim 1, wherein the first magnet and the second magnet have respective upper surfaces in the axial direction, of which one height is equal to or higher than the other height.

5. The bearing assembly as set forth in claim 1, further includes a hydrodynamic bearing part including:
a radial dynamic part having the shaft and the sleeve facing each other in the axial direction; and
a thrust dynamic part by a thrust plate formed to face an end portion of the sleeve.

6. The bearing assembly as set forth in claim 1, wherein the shaft or the sleeve is formed of a magnetic material.

7. A spindle motor, comprising:
the bearing assembly as set forth in claim 1;
a base coupled with the sleeve and having a coil-wound core mounted thereon; and
a hub having a magnet mounted thereon to face the core and coupled with the shaft at the rotation center thereof.
